(19) United States
(12) Patent Application Publication
(10) Pub. No.: US 2015/0212758 A1
(43) Pub. Date: Jul. 30, 2015

(54) FORENSIC ANALYSIS SYSTEM AND METHOD USING VIRTUALIZATION INTERFACE

(71) Applicant: Electronics and Telecommunications Research Institute, Daejeon (KR)

(72) Inventors: Sang Su LEE, Daejeon (KR); Sung Kyong UN, Daejeon (KR); Su Hyung JO, Daejeon (KR); Joo Young LEE, Daejeon (KR); Keon Woo KIM, Daejeon (KR); Woo Yong CHOI, Daejeon (KR)

(73) Assignee: Electronics and Telecommunications Research Institute, Daejeon (KR)

(21) Appl. No.: 14/605,429

(22) Filed: Jan. 26, 2015

(30) Foreign Application Priority Data
Jan. 28, 2014 (KR) 10-2014-0010612

(51) Int. Cl. G06F 3/06

(52) U.S. Cl. CPC G06F 3/0655; G06F 3/0608; G06F 3/0664; G06F 3/067

(57) ABSTRACT

A forensic analysis system and method using a virtualization interface which performs a forensic investigation or analysis on a corresponding system while minimizing a change in system information and operation interference of a live computer which is being operated is provided. In the forensic analysis system which performs a forensic analysis through a connection between an investigation target computer and an analysis computer, the investigation target computer is configured to execute a collection agent installation program stored in the analysis computer, and transmit analysis target information according to a request of the analysis computer.

### CROSS-REFERENCE TO RELATED APPLICATION

This application claims priority to and the benefit of Korean Patent Application No. 10-2014-0010612, filed on Jan. 28, 2014, the disclosure of which is incorporated herein by reference in its entirety.

### BACKGROUND

1. Field of the Invention

The present invention relates to a forensic analysis system and method using a virtualization interface, and more particularly, to a forensic analysis system and method using a virtualization interface capable of minimizing a change in system information and operation interference of a live computer which is being operated, and also performing a forensic investigation or analysis on a corresponding system.

2. Discussion of Related Art

A digital forensic technology is a field of finding a crucial evidence using information generated by a computer in a criminal investigation. According to developments of information technology, most information become digitalized, and in the criminal investigation, etc., an object obtaining an evidential material or data information become changed from an analog medium such as a paper document to a digital medium such as a hard disk.

However, since the digital information is very easy to be discarded, it is difficult to acquire a related evidence. In such a digital environment, a method of acquiring the information which is erased or deleted through a digital storage medium such as a hard disk, etc. is needed. This technology is referred to as the digital forensic technology.

Meanwhile, a live forensic analysis is technology of acquiring various system-related information stored in a memory of a target system such as process information which is being operated in a system which is currently being operated unlike a conventional computer forensic investigation.

Particularly, recently, due to the spread of technology of fundamentally encrypting the hard disk which is a main data storage medium of a system device like disk volume encryption technology such as BitLocker supported in a Microsoft Windows system, it becomes more difficult to apply conventional disk imaging technology of separating the hard disk of an evidence computer and copying every contents, and dependence on live system analysis technology is increased.

Generally, in the live system analysis technology, since a program for analysis is installed in a corresponding system, there is a concern of possibly changing system information of the corresponding system. Accordingly, various technologies for minimizing the concern are being used, and recently, a method of driving in the corresponding system after connecting a universal serial bus (USB) memory device in which the program for analysis is stored to a USB connection interface of the corresponding system is widely being used.

However, the method has the following two problems. First, after connecting the USB for analysis, an investigator has to connect to a console or a terminal of the corresponding computer.

There is not a big problem in a multi-user system such as Unix, but in conventional Windows, there is a disadvantage in which an owner or an original user of the corresponding computer cannot perform any job using the corresponding computer during the forensic investigation since a multi-connection of a multi-user is not easy.

Of course, it cannot be a disadvantage for stability of the forensic investigation, but as a condition allowing search and seizure by a court with respect to a computer of a suspect becomes tricky, the disadvantage can be greatly emerged since a case in which the suspect does not agree with a shutdown of the computer because of his work frequently occurs.

Next, there is a problem in a method in which a result collected by the program for analysis is stored in not a corresponding system but a mobile storage device itself in which the program for analysis is stored. In this case, a capacity problem of the USB storage device may occur, and there is an inconvenience in which the USB storage device has to be moved to an analysis computer in order to analyze the collected data.

### SUMMARY OF THE INVENTION

The present invention is directed to a forensic analysis system and method using a virtualization interface capable of minimizing a change in system information and operation interference of a live computer which is being operated, and also performing a forensic investigation or analysis on a corresponding system.

According to one aspect of the present invention, there is provided a forensic analysis system using a virtualization interface which performs a forensic analysis through a connection between an investigation target computer and an analysis computer, wherein the investigation target computer is configured to execute a collection agent installation program stored in the analysis computer, and transmit analysis target information according to a request of the analysis computer.

The analysis computer may include: a virtual storage device configured to emulate a USB storage device; a forensic analysis unit configured to perform the forensic analysis on the analysis target information; and a physical storage device configured to store the analysis target information and the collection agent installation program.

The virtual storage device may include: a processing unit configured to transmit a request for the analysis target information to the investigation target computer, and receive corresponding analysis target information; a communication unit configured to communicate with the investigation target computer; and a file conversion unit configured to convert the analysis target information into a type for using in the analysis computer.

The communication unit may be a communication port selector configured to select so that the virtual storage device uses a specific port set by a user.

The investigation target computer may include: an investigation target storage device configured to store every data generated while the investigation target computer operates; and a collection agent generated by executing the collection agent installation program, and configured to collect the analysis target information and transmit the collected analysis target information to the analysis computer.

The collection agent may include: a communication unit configured to communicate with the analysis computer; and a collection unit configured to receive the request for the analysis target information from the analysis computer through the communication unit, collect the corresponding analysis target information, and transmit the collected analysis target information to the analysis computer.

According to another aspect of the present invention, there is provided a forensic analysis method using a virtualization interface, including: connecting an analysis computer to an investigation target computer, and generating a collection agent in the investigation target computer; transmitting, by the analysis computer, a request for analysis target information to the investigation target computer, and receiving a corresponding analysis target information from the investigation target computer; and performing, by a forensic analysis unit, a forensic analysis on the analysis target information.

At this time, the generating of the collection agent may include recognizing and executing a collection agent installation program stored in the analysis computer after the investigation target computer is connected to the analysis computer.

Meanwhile, when the performing of the forensic analysis is completed, the forensic analysis method may further include separating the analysis computer from the investigation target computer, and releasing a connection between the investigation target computer and the analysis computer.

Further, the transmitting of, by the analysis computer, the request for analysis target information to the investigation target computer, and receiving of the corresponding analysis target information from the investigation target computer, may include: transmitting the request for the analysis target information input through a user interface to the investigation target computer through a virtual storage device; when the investigation target computer receives the request for the analysis target information, decoding, by the collection agent, the request for the analysis target information, collecting the requested analysis target information, and providing the collected analysis target information to the analysis computer; and when the analysis computer receives the analysis target information, converting, by a file conversion unit, the analysis target information into a type for using in the analysis computer, and storing the converted analysis target information in a physical storage device.

### BRIEF DESCRIPTION OF THE DRAWINGS

The above and other objects, features, and advantages of the present invention will become more apparent to those of ordinary skill in the art by describing in detail exemplary embodiments thereof with reference to the accompanying drawings, in which:

FIG. 1 is a block diagram illustrating a construction of a forensic analysis system using a virtualization interface according to an embodiment of the present invention;

FIG. 2 is a detailed block diagram illustrating a virtual storage device of a forensic analysis system using a virtualization interface according to an embodiment of the present invention;

FIG. 3 is a detailed block diagram illustrating a collection agent of a forensic analysis system using a virtualization interface according to an embodiment of the present invention;

FIGS. 4A and 4B are diagrams for describing a connection operation of an analysis computer and an investigation target computer according to an embodiment of the present invention; and

FIG. 5 is a flowchart for describing an analysis operation according to a forensic analysis method using a virtualization interface according to an embodiment of the present invention.

### DETAILED DESCRIPTION OF EXEMPLARY EMBODIMENTS

Example embodiments of the present invention are described below in sufficient detail to enable those of ordinary skill in the art to embody and practice the present invention with reference to accompanying drawings. Widths of lines or sizes of components shown in the drawings may be overly illustrated for clarity and brevity for explanation. Further, all terms used herein are defined by considering functions of components in the present invention, and their meaning may differ according to intentions or customs. Therefore, the terms should be defined based on the description of this specification.

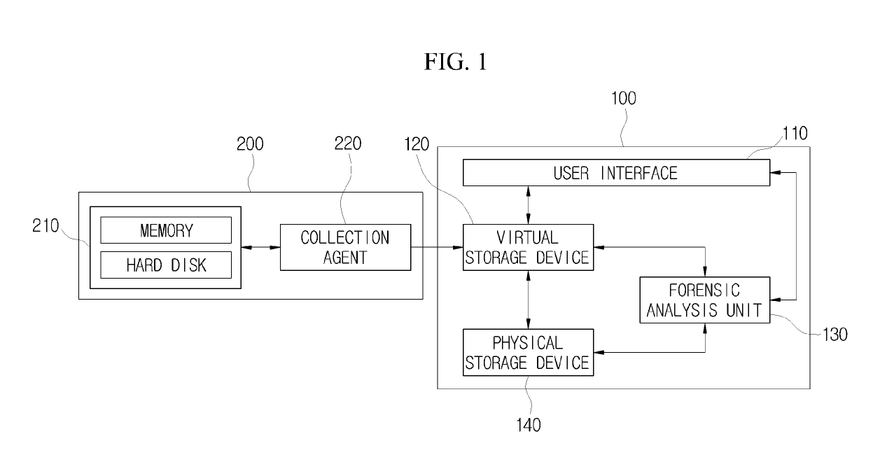

FIG. 1 is a block diagram illustrating a forensic analysis system using a virtualization interface according to an embodiment of the present invention.

Referring to FIG. 1, the forensic analysis system using the virtualization interface according to an embodiment of the present invention may include an analysis computer 100, and an investigation target computer 200.

The analysis computer 100 may transmit a request for analysis target information to the investigation target computer 200, receive the analysis target information from the investigation target computer 200, and perform a forensic analysis on the analysis target information.

The analysis computer 100 may include a user interface 110, a virtual storage device 120, a forensic analysis unit 130, and a physical storage device 140.

The user interface 110 may be provided so that a user performs an information collection and analysis, a communication port setting, etc., and the user may perform a request for the information collection, an analysis for the collected information, a communication port setting with the investigation target computer 200, etc. through the user interface 110.

The virtual storage device 120 may be a virtual USB device emulating a USB storage device, and when the investigation target computer 200 is connected to the analysis computer 100, recognize as the USB storage device.

The forensic analysis unit 130 may perform a forensic analysis on the analysis target information collected from the investigation target computer 200.

At this time, the forensic analysis unit 130 may perform the forensic analysis on the analysis target information by receiving the analysis target information from the virtual storage device 120, or perform the forensic analysis on the analysis target information by receiving the analysis target information stored in the physical storage device 140.

The physical storage device 140 may store information for overall operations of the analysis computer 100, the analysis target information received through the virtual storage device 120, forensic analysis result data, etc.

Particularly, when the investigation target computer 200 is connected, the physical storage device 140 may store a collection agent installation program so that the investigation target computer 200 performs a collection agent function.

The investigation target computer 200 may include an investigation target storage device 210, and a collection agent 220.

The investigation target storage device 210 may store every data generated while the investigation target computer 200 operates, and the every data may be an analysis target of the analysis computer 100. The investigation target storage device 210 may be configured as a memory and a hard disk.

When the collection agent 220 receives the request for the analysis target information from the analysis computer 100, the collection agent 220 may collect corresponding analysis target information from the investigation target storage device 210, and provide the collected analysis target information to the analysis computer 100. At this time, the collection agent 220 may be connected to the virtual storage device 120 of the analysis computer 100, and be configured to transmit and receive information.

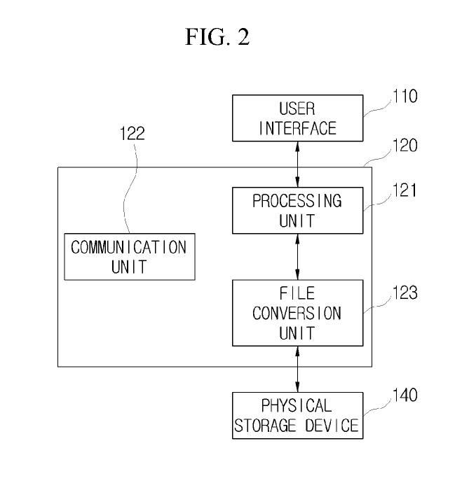

FIG. 2 is a detailed block diagram illustrating a virtual storage device of a forensic analysis system using a virtualization interface according to an embodiment of the present invention.

Referring to FIG. 2, the virtual storage device 120 may include a processing unit 121, a communication unit 122, and a file conversion unit 123.

The processing unit 121 may transmit a request for the analysis target information to the investigation target computer 200, and receive corresponding analysis target information transmitted from the investigation target computer 200.

The communication unit 122 may communicate with the investigation target computer 200, and perform a communication port function. For example, when there are a plurality of communication ports in the analysis computer 100, the communication unit 122 may be a communication port selector configured to select so that the virtual storage device 120 uses only a specific port set by a user through the user interface 110.

Accordingly, before connecting the analysis computer 100 with the investigation target computer 200, the user may have to set a communication port used by the communication unit 122 through the user interface 110.

Further, the user may have to set a size and a partition, etc. of the physical storage device 140 which is mapped with the virtual storage device 120 through the user interface 110.

The file conversion unit 123 may convert the analysis target information received from the investigation target computer 200 into a type capable of being used in the analysis computer 100.

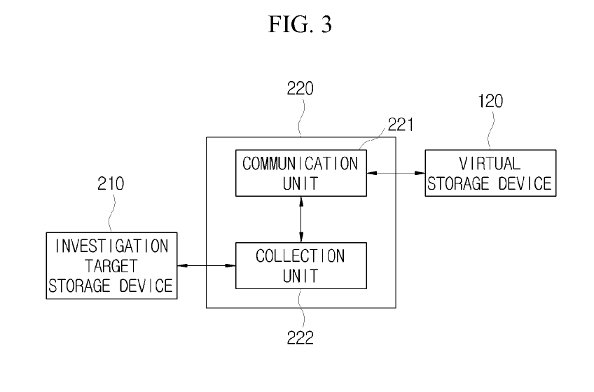

FIG. 3 is a detailed block diagram illustrating a collection agent of a forensic analysis system using a virtualization interface according to an embodiment of the present invention.

Referring to FIG. 3, the collection agent 220 may include a communication unit 221 and a collection unit 222.

The communication unit 221 may communicate with the analysis computer 100, and particularly, with the virtual storage device 120, and be directly connected with the communication unit 122 of the virtual storage device 120.

The collection unit 222 may decode a request command from the analysis computer 100, collect the requested analysis target information, and provide the collected analysis target information.

The analysis target information collected by the collection unit 222 may be transmitted to the analysis computer 100 through the USB port by the communication unit 221.

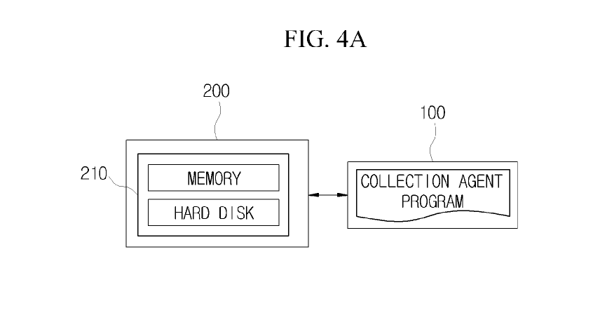

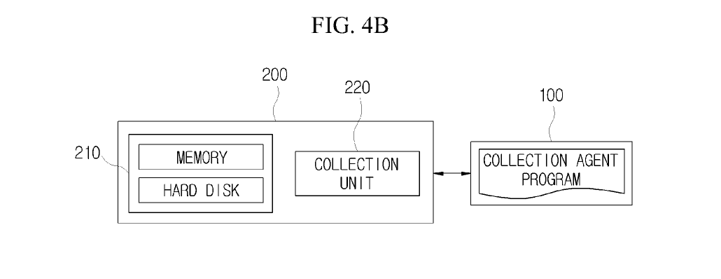

FIGS. 4A and 4B are diagrams for describing a connection operation of an analysis computer and an investigation target computer according to an embodiment of the present invention.

When the analysis computer 100 is connected to the investigation target computer 200, as shown in FIG. 4A, the investigation target computer 200 may not recognize the construction of FIG. 2 at all, and may execute the collection agent installation program according to a method of executing a program installed in a conventional USB storage device. As shown in FIG. 4B, the collection agent 220 may start an operation by being installed in the investigation target computer 200.

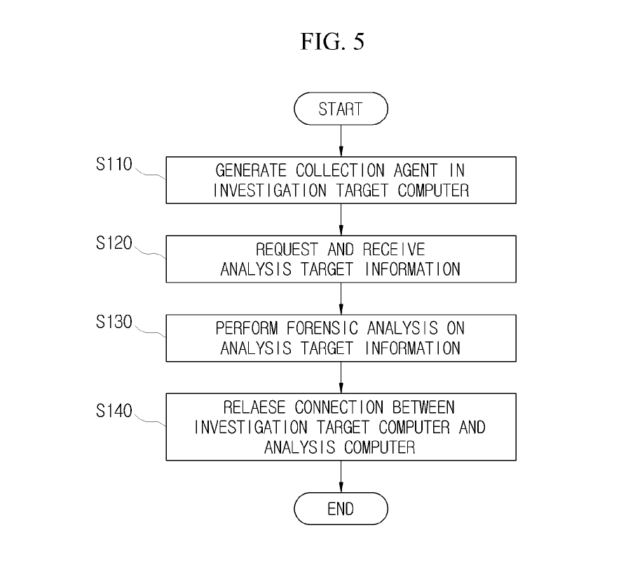

FIG. 5 is a flowchart for describing an analysis operation according to a forensic analysis method using a virtualization interface according to an embodiment of the present invention.

Referring to FIG. 5, first, the analysis operation may include connecting the analysis computer 100 and the investigation target computer 200, and generating the collection agent 220 in the investigation target computer 200 (S110). At this time, the collection agent installation program may be stored in the analysis computer 100, and after the analysis computer 100 is connected to the investigation target computer 200, the investigation target computer 200 may generate the collection agent 220 by recognizing and executing the collection agent installation program.

After this, the analysis operation may include transmitting a request for the analysis target information to the investigation target computer 200, and receiving corresponding analysis target information from the investigation target computer 200 (S120).

At this time, the request for the analysis target information may be input by a user or an analyst through the user interface 110, and the request for the analysis target information input through the user interface 110 may be transmitted to the investigation target computer 200 through the virtual storage device 120.

Further, when the investigation target computer 200 receives the request for the analysis target information, the collection agent 220 may decode the request for the analysis target information, collect the requested analysis target information, and provide the collected analysis target information to the analysis computer 100.

When the analysis computer 100 receives the analysis target information, the file conversion unit 123 may convert the analysis target information into the type capable of being used in the analysis computer 100, and store the converted analysis target information in the physical storage device 140.

Next, the analysis operation may include performing the forensic analysis on the stored analysis target information by the forensic analysis unit 130 (S130). At this time, a result analyzed by the forensic analysis unit 130 may be stored in the physical storage device 140.

When the forensic analysis by the forensic analysis unit 130 is completed, the analysis operation may include separating the analysis computer 100 from the investigation target computer 200, and thus releasing the connection between the analysis computer 100 and the investigation target computer 200 (S140).

Accordingly, since the present invention can perform the forensic analysis on the analysis target information stored in the investigation target computer in a separate analysis computer apart from the investigation target computer, a user of the investigation target computer can use the investigation target computer regardless of the analysis.

Further, in the conventional art, the analysis target information is collected in the USB, and the forensic analysis is performed by connecting the USB to the analysis computer. However, the present invention may prepare the virtual storage device in the analysis computer, collect the analysis target information stored in the investigation target computer using the virtual storage device, and directly store the collected analysis target information in the analysis computer.

Accordingly, the present invention can solve a problem of lack of a storage space and an inconvenience of having to attach and detach the USB to the analysis computer, when using the USB.

According to the forensic analysis system and method using the virtualization interface, every operation of collecting and analyzing can be performed in the analysis computer after the collection agent program is installed in the investigation target computer.

Accordingly, the forensic investigation or analysis on a corresponding system can be performed while minimizing the change in the system information and the operation interference of the live computer which is being operated.

Although the forensic analysis system and method using the virtualization interface of the present invention was described according to an embodiment, the scope of the prevent invention is not limited thereto, and various substitutions, modifications, and changes can be made within a range which is obvious to those of ordinary skill in the art.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. A forensic analysis system using a virtualization interface which performs a forensic analysis through a connection between an investigation target computer and an analysis computer,
wherein the investigation target computer is configured to execute a collection agent installation program stored in the analysis computer, and transmit analysis target information according to a request of the analysis computer.

2. The forensic analysis system using the virtualization interface according to claim 1, wherein the analysis computer comprises:
a virtual storage device configured to emulate a USB storage device;
a forensic analysis unit configured to perform the forensic analysis on the analysis target information; and
a physical storage device configured to store the analysis target information and the collection agent installation program.

3. The forensic analysis system using the virtualization interface according to claim 2, wherein the virtual storage device comprises:
a processing unit configured to transmit a request for the analysis target information to the investigation target computer, and receive corresponding analysis target information;
a communication unit configured to communicate with the investigation target computer; and
a file conversion unit configured to convert the analysis target information into a type for using in the analysis computer.

4. The forensic analysis system using the virtualization interface according to claim 3, wherein the communication unit is a communication port selector configured to select so that the virtual storage device uses a specific port set by a user.

5. The forensic analysis system using the virtualization interface according to claim 1, wherein the investigation target computer comprises:
an investigation target storage device configured to store every data generated while the investigation target computer operates; and
a collection agent generated by executing the collection agent installation program, and configured to collect the analysis target information and transmit the collected analysis target information to the analysis computer.

6. The forensic analysis system using the virtualization interface according to claim 5, wherein the collection agent comprises:
a communication unit configured to communicate with the analysis computer; and
a collection unit configured to receive the request for the analysis target information from the analysis computer through the communication unit, collect the corresponding analysis target information, and transmit the collected analysis target information to the analysis computer.

7. A forensic analysis method using a virtualization interface, comprising:
connecting an analysis computer to an investigation target computer, and generating a collection agent in the investigation target computer;
transmitting, by the analysis computer, a request for analysis target information to the investigation target computer, and receiving a corresponding analysis target information from the investigation target computer; and
performing, by a forensic analysis unit, a forensic analysis on the analysis target information.

8. The forensic analysis method using the virtualization interface according to claim 7, wherein the generating of the collection agent comprises recognizing and executing a collection agent installation program stored in the analysis computer after the investigation target computer is connected to the analysis computer.

9. The forensic analysis method using the virtualization interface according to claim 7, when the performing of the forensic analysis is completed, further comprising separating the analysis computer from the investigation target computer, and releasing a connection between the investigation target computer and the analysis computer.

10. The forensic analysis method using the virtualization interface according to claim 7, wherein the transmitting of, by the analysis computer, the request for analysis target information to the investigation target computer, and receiving of the corresponding analysis target information from the investigation target computer, comprises:
transmitting the request for the analysis target information input through a user interface to the investigation target computer through a virtual storage device;
when the investigation target computer receives the request for the analysis target information, decoding, by the collection agent, the request for the analysis target information, collecting the requested analysis target information, and providing the collected analysis target information to the analysis computer; and
when the analysis computer receives the analysis target information, converting, by a file conversion unit, the analysis target information into a type for using in the analysis computer, and storing the converted analysis target information in a physical storage device.
